(19) United States
(12) Patent Application Publication
(10) Pub. No.: US 2021/0308790 A1
(43) Pub. Date: Oct. 7, 2021

(54) Method for Welding a Zinc-Coated Motor Vehicle Component

(71) Applicant: Bayerische Motoren Werke Aktiengesellschaft, Muenchen (DE)

(72) Inventors: Clemens BERGMANN, Muenchen (DE); Florian HOFBAUER, Geratskirchen (DE); Joerg ZIMMERMANN, Kumhausen (DE)

(21) Appl. No.: 17/264,694

(22) PCT Filed: Jul. 4, 2019
(86) PCT No.: PCT/EP2019/067938

§ 371 Date: Jan. 29, 2021

(30) Foreign Application Priority Data
Aug. 1, 2018 (DE) 10 2018 212 810.3

(51) Int. Cl. B23K 26/0622; B23K 26/322; B23K 26/60; B23K 26/36

(52) U.S. Cl. CPC B23K 26/0622; B23K 26/322; B23K 2101/006; B23K 26/36; B23K 26/60

(57) ABSTRACT

The invention relates to a method for welding a zinc-coated motor vehicle component (1), in which a welding surface (3) of the zinc-coated motor vehicle component (1) is pretreated and a connecting element is subsequently welded on at the welding surface (3), wherein for the pretreatment the zinc layer (2) is deposited to a prescribed maximum layer thickness (6) in the region of the welding surface (3) by means of a laser device (5).

### BACKGROUND AND SUMMARY OF THE INVENTION

This disclosure relates to a method for welding a zinc-coated motor vehicle component.

In a method for improving the weldability of zinc-coated steel plates by pretreating the surface thereof in a joining region intended for a welded connection, a jet of an atmospheric, electrically neutral low-temperature plasma may be directed onto the surface and the steel plates may be welded to one another by means of a laser.

One of the objects of the present disclosure is to provide a method for welding a zinc-coated motor vehicle component that allows particularly easy preparation of a welding surface of the zinc-coated motor vehicle component and at the same time particularly advantageous and clean welding of the zinc-coated motor vehicle component at the welding surface.

This and other objects are achieved by a method for welding a zinc-coated motor vehicle component in which a welding surface of the zinc-coated motor vehicle component is pretreated and a connecting element is subsequently welded onto the welding surface. In order to allow particularly advantageous welding of the motor vehicle component to the connecting element at the welding surface, it is provided according to this disclosure that, for the pre-treatment, the zinc layer is removed to a specified maximum layer thickness in the region of the welding surface by means of a laser device. In particular, the pre-treatment serves for ensuring process stability with constant welding parameters, in particular when there is an irregular zinc layer on the motor vehicle component. By means of the laser device, the zinc layer is pre-evaporated in the region of the welding surface, in order to set a defined layer thickness of the zinc layer. In this case, the zinc layer may be removed completely by means of the laser device in the region of the welding surface or merely reduced to a layer thickness that can be welded with specified, constant welding parameters. Consequently, the method allows that zinc-coated motor vehicle components with zinc layers of different thicknesses can be welded with constant welding parameters to a constant welding quality.

This method has been found to be particularly advantageous in the case of a motor vehicle component that is in particular hot galvanized, since in hot galvanizing the motor vehicle component is dipped in molten zinc and thereby zinc-coated. This is a piecework zinc process. In hot galvanizing, which represents a particularly easy and inexpensive possible way of zinc coating the motor vehicle component, different thicknesses of the zinc layer may be obtained at different points of the motor vehicle component. A thickness of the zinc layer that is likely to be produced at the welding surface after hot galvanizing is not at all predictable, or if so only with particularly great effort, and so setting the welding parameters to the layer thickness of the zinc layer that occurs in each case at the welding surface is particularly laborious and time-intensive. The method offers the advantage that the thickness of the zinc layer can be adapted to the constant welding parameters by means of the laser device. Consequently, the method allows hot galvanized motor vehicle components to be welded.

In a further advantageous refinement of this disclosure, it is provided that the motor vehicle component is generatively manufactured or cast. A generative manufacturing process is an additive manufacturing process in which the motor vehicle component is built up and produced layer by layer. If the motor vehicle component is cast, to produce the motor vehicle component a molten metal is poured into a mold, in order to solidify there and, in the solidified state, be removed from the mold as the motor vehicle component. Consequently, the generatively manufactured or cast motor vehicle component is a metallic component which is provided with the zinc layer. In the case of generative manufacturing, as in the case of casting of the motor vehicle component, the motor vehicle component has a particularly great surface roughness. When zinc coating this particularly rough surface, and in particular when hot galvanizing this particularly rough surface, a zinc coating of the motor vehicle component that has varying layer thicknesses over a surface of the motor vehicle component is produced. In particular, the layer thickness of the zinc layer may vary along the welding surface, and so welding of the motor vehicle component to the connecting element with constant welding parameters is made more difficult. In order to allow particularly easy welding of the motor vehicle component to the connecting element, the thickness of the zinc layer is set to a specified layer thickness along the entire welding surface by means of the laser device. As a result, a particularly good welding result of the weld seam of the connecting element to the motor vehicle component can be achieved.

In a further advantageous refinement of this disclosure, it is provided that the welding surface is pretreated by means of a pulsed high-power solid-state laser. This involves a pulsed laser beam being directed onto the zinc layer by means of the high-power solid-state laser in order to pre-evaporate the zinc layer. The high-power solid-state laser allows a particularly high melting rate of the laser device when pre-evaporating the zinc layer, and so the zinc layer can be set particularly quickly to a specified layer thickness.

In a further advantageous refinement of this disclosure, it is provided that a laser beam provided by means of the laser device is guided over the welding surface by means of a deflecting device. The deflecting device may be designed to guide the laser beam two-dimensionally or three-dimensionally over the welding surface of the motor vehicle component. This allows particularly precise setting of the layer thickness of the zinc layer in the region of the welding surface. As a result, depositing of the zinc layer over a wide area on a surface of the motor vehicle component that is not the welding surface can be avoided. In particular, only the surface area of the zinc layer that represents the welding surface can be pretreated by means of the laser device, and so corrosion protection for the motor vehicle component that is provided by the zinc layer can be obtained particularly well, since the zinc layer outside the welding surface remains unchanged.

In a further advantageous refinement of this disclosure, it is provided that the motor vehicle component is laser-welded to the connecting element. This allows the motor vehicle component to be welded to the connecting element particularly easily and quickly. Consequently, the laser device can for example be advantageously used on the one hand for pretreating the welding surface of the motor vehicle component and on the other hand for welding the motor vehicle component to the connecting element. The welding of the motor vehicle component can consequently be performed by means of a particularly small number of processing components.

In a further refinement of this disclosure, it has been found to be advantageous if the motor vehicle component is painted after welding to the connecting element. This may involve the motor vehicle component and the welded-on connecting element being provided with a coat of paint for example in the course of a cathodic dip-painting operation. This coat of paint forms additional corrosion protection for an assembly comprising the motor vehicle component and the connecting element. The painting of the assembly comprising the motor vehicle component and the connecting element after the welding ensures that the welding surface remains free of paint, and consequently the welding of the motor vehicle component is not adversely influenced by paint on the welding surface.

Further features of this disclosure emerge from the claims, the figures and the description of the FIGURES. The features and combinations of features mentioned above in the description and the features and combinations of features mentioned in the description of the FIGURES below and/or shown in the FIGURES alone can be used not only in the respectively stated combination but also in other combinations or alone.

This disclosure is now explained in more detail on the basis of a preferred exemplary embodiment and also with reference to the drawing, in which:

### BRIEF DESCRIPTION OF THE DRAWING

FIG. 1 shows a schematic sectional view of a zinc-coated motor vehicle component of which the zinc layer is evaporated in the region of a welding surface by a laser device.

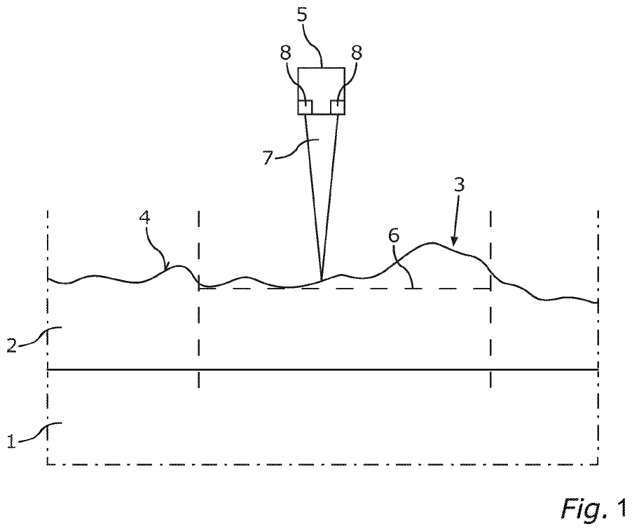

### DETAILED DESCRIPTION OF THE DRAWING

In the single FIGURE, a zinc-coated motor vehicle component 1 is shown in section. The motor vehicle component 1 is a cast part, which has been provided with a zinc layer 2 in the course of a hot galvanizing operation. In the course of an assembly operation of the motor vehicle component 1 for assembling a motor vehicle, in particular a motor car, the motor vehicle component 1 is intended to be welded to a connecting element that is not represented in the single FIGURE. For this, the zinc-coated motor vehicle component 1 has a welding surface 3, along which the zinc-coated motor vehicle component 1 is to be welded to the connecting element.

As can be seen in the single FIGURE, the zinc layer 2 has an irregular surface 4, and so the zinc layer 2 has a varying layer thickness over its extent, and in particular in the region of the welding surface 3. In order to achieve a constant welding quality of the motor vehicle component 1 to the connecting element, the motor vehicle component 1 and the connecting element are welded with constant welding parameters. In order to achieve a constant welding quality with constant welding parameters, in the course of a pretreatment the zinc layer 2 is removed in the region of the welding surface 3 to a specified maximum layer thickness 6 by means of a laser device 5.

The laser device 5 is in the present case a pulsed high-power solid-state laser. In order to be able to guide a laser beam 7 generated by means of the laser device 5 particularly well over the surface 4 of the zinc layer 2 and set the layer thickness of the zinc layer 2 particularly precisely to the maximum layer thickness 6, the laser device 5 comprises a deflecting device 8, by means of which the laser beam 7 can be guided over the surface 4 of the zinc layer 2. After the pretreatment of the welding surface 3, the motor vehicle component 1 is laser-welded to the connecting element at the welding surface 3 to form an assembly. Subsequently, the assembly comprising the motor vehicle component 1 and the connecting element is provided with a layer of paint in the course of a painting process.

At present, it is scarcely possible to conventionally weld zinc-coated components with a zinc layer thickness of more than 15 micrometers. In order to coat a component with a zinc layer with a thickness of seven to 15 micrometers, at present electrocoating processes are used. In the case of electrocoating processes, the component is coated with zinc in an aqueous solution, and so, after the zinc coating, water may disadvantageously adhere to a component surface and lead to inferior welding quality during welding of the component, in particular because of blistering during the welding. By contrast with electrocoating processes, piecework zinc coating operations, to be understood as meaning hot galvanizing processes on a hot galvanizing installation, have commercial and qualitative advantages, since in particular the motor vehicle component 1 to be hot galvanized does not in this case come into contact with water, but only with the molten zinc during the zinc coating. As a result, adverse impairment of a welding quality of a welded zinc-coated component, in particular the motor vehicle component 1, can be prevented. In the case of piecework zinc coating operations, in particular hot-dip zinc coating, which is another name for hot galvanizing, the layer thickness of the zinc layer 2 on the welding surface 3 cannot be controlled, or only with difficulty. In addition, the zinc layer 2 may have a thickness of more than 15 micrometers, at least in certain regions, since the thickness of the zinc layer 2 in hot galvanizing can only be set with difficulty. In order to allow the welding in spite of the irregular surface 4 of the zinc layer 2, the zinc layer 2 is locally removed by means of a laser technique, in the present case by means of the laser device 5. For this purpose, the pulsed laser beam 7 of the laser device 5 formed as a high-power solid-state laser is focused two-dimensionally and/or three-dimensionally onto desired points of the surface 4 of the zinc layer 2 by means of the deflecting device 8.

With respect to the method, it is advantageous in particular that hot galvanizing is particularly inexpensive in comparison with laborious zinc electrocoating, and so, in the course of the hot galvanizing, the motor vehicle component 1 can be provided with the zinc layer 2 particularly inexpensively. Moreover, with the hot galvanizing of the motor vehicle component 1, a better surface quality of the surface 4 of the zinc layer 2 is achieved in comparison with zinc electrocoating, since the zinc layer 2 is applied at a particularly high temperature. The high temperature during the layer application of the zinc layer 2 has the effect that impurities and also inclusions of gas and moisture are driven out of the zinc layer 2 and from a surface of the motor vehicle component.

### LIST OF DESIGNATIONS

1 Motor vehicle component
2 Zinc layer
3 Welding surface
4 Surface
5 Laser device
6 Maximum layer thickness
7 Laser beam
8 Deflecting device

1.-7. (canceled)

8. A method for welding a zinc-coated motor vehicle component, comprising:
pre-treating a welding surface of the zinc-coated motor vehicle component; and
subsequently welding a connecting element onto the pre-treated welding surface, wherein
in the pre-treating, a zinc layer is removed to a specified maximum layer thickness in a region of the welding surface with a laser device.

9. The method according to claim 7, wherein the zinc-coated motor vehicle component is hot galvanized.

10. The method according to claim 9, wherein the zinc-coated motor vehicle component is generatively manufactured or cast.

11. The method according to claim 10, wherein the welding surface is pretreated with a pulsed high-power solid-state laser.

12. The method according to claim 11, wherein the laser device generates a laser beam that is guided over the welding surface by a deflecting device.

13. The method according to claim 12, wherein the zinc-coated motor vehicle component is laser-welded to the connecting element.

14. The method according to claim 12, wherein the zinc-coated motor vehicle component is painted after welding to the connecting element.
